(19) United States
(12) Patent Application Publication
(10) Pub. No.: US 2004/0089184 A1
(43) Pub. Date: May 13, 2004

(54) Method of applying high-fidelity color printed indicia to a golf ball

(76) Inventors: Daniel B. Lampinski, Pawtucket, RI (US); Richard W. Smith, Whitman, MA (US); Matthew M. Semiao, North Dartmouth, MA (US)

Correspondence Address: Edward A. Pennington, Esq., Swidler Berlin Shereff Friedman, LLP, Suite 300, 3000 K. Street, N.W., Washington, DC, 20007-5116, US

(21) Appl. No.: 10/703,495

(22) Filed: Nov. 10, 2003

Related U.S. Application Data
(62) Division of application No. 09/829,994, filed on Apr. 11, 2001.
(60) Provisional application No. 60/199,832, filed on Apr. 26, 2000.

(51) Int. Cl. B41F 17/00; B41C 1/00; B41M 1/00

(52) U.S. Cl. 101/483; 101/41

(57) ABSTRACT

A method of printing indicia on a golf ball having a dimpled surface including the steps of providing a color image having a plurality of colors; saving the color image into computer memory as a digital image; creating at least six digital copies of the digital image and assigning at least one digital copy to each of at least six color channels; filtering the plurality of colors into the at least six color channels by removing all but an assigned color of that color channel from each corresponding digital copy resulting in at least six color separations; creating a film positive for each of the at least six color separations; placing the film positive on a pad-printing cliché; etching the film positive into the pad-printing cliché creating a transfer image; distributing a layer of ink over the pad-printing cliché; and printing the transfer image from the surface of the pad-printing cliché to the dimpled surface of the golf ball.

### CROSS-REFERENCE TO RELATED APPLICATION(S)

This application claims priority to U.S. Provisional Application No. 60/199,832, filed Apr. 26, 2000.

### FIELD OF THE INVENTION

This invention relates to a method for printing a high-fidelity color image on three dimensional surfaces and, more particularly, the dimpled surfaces of golf balls.

### BACKGROUND OF THE INVENTION

Printing indicia on a variety of three-dimensional surfaces, such as sporting goods, in particular, golf equipment, is prevalent as a means of advertising and labeling. Hundreds of millions of golf balls are produced each year, a significant percentage of which have some type of decorative logo printed on the surface. For example, many golf balls contain logos that advertise or identify a particular company, product, private and public golf courses, country clubs, and resorts.

Two different approaches, decal application and pad-printing, are commonly used to add decorative logos to three-dimensional surfaces, in particular, the dimpled surfaces of golf balls. The first approach involves first creating a decal of the logo or indicia that is to be printed on the golf ball surface, applying the decal to the spherical, dimpled golf ball surface of the cover, and then spraying the golf ball surface and decal with a clear finish coating. This decal process is limited in several different ways. First, decals are generally purchased by the golf ball manufacturer from a vendor or secondary printing source. Defective, off-color, or damaged decals must be returned to the vendor for re-printing. This additional step, if necessary, has the potential to cause delays that are typically passed on to the customer. In the golf ball industry, it is vital that customers receive their orders within a competitive time frame.

It is well known to one of ordinary skill in the art that decals are expensive. Furthermore, the material and labor costs for applying the decals to the dimpled surface of a golf ball averages four to seven times more than pad-printing logos onto a golf ball. Additionally, the variety of colors and/or shading of those colors is frequently limited by the manufacturing and printing process of decals. Decals are typically made using a silk screening process, which by nature tends to limit the number of possible colors and inhibits the use of shading.

The second approach to adding a logo to the dimpled surface of a golf ball is pad-printing. Pad-printing is an indirect intaglio process, meaning that the image results from transferring an image first created, i.e., etched, onto a secondary source. Depressions representing the logo of choice are generally created in a flat-surfaced object called “the plate” or pad-printing cliché. Of the two types of plates, variable- and fixed-depth relief plates, the most commonly used in pad-printing are variable-depth plates. The depressions for logos or indicia having multiple colors require multiple plates, each plate is dedicated to a specific individual color of the image to be printed. For example, in the case of 4-color process printing, there would be a plate for cyan, magenta, yellow, and black. In general, a plate is etched with each part of a logo that is to receive a specific color in the logo (for spot color printing) or for the relative contribution of each color in a print series (i.e., 4-color process printing). This is usually accomplished by exposing a photoactive polymer layer on the plate to ultraviolet light through a film positive placed on top of the layer.

After an initial exposure period, the plate is completely covered with a screen film and exposed to UV light again, a process known as screening. Screening effectively places many small “dots,” in the shape of truncated cones, into the surface of the etched image itself. This step is not necessary for fixed-depth relief plates.

The pad-printing process itself generally begins by spreading ink across the surface of the etched plate with a spatula. Excess ink is then scraped back into an ink reservoir using a “doctor blade”, leaving ink only in the depressions on the plate. The screened “dots” that were placed onto the etched surface aid in keeping the doctor blade from pressing into the etched area. If the doctor blade is allowed to bend or compress, the result would be varied areas of ink and, subsequently, inconsistent ink transfer to the printable golf ball surface. As the plate is exposed to air, thinner in the ink evaporates from the remaining ink in the depressions, thereby causing the ink surface to become tacky.

A smooth, resilient, silicone rubber stamp block is used to lift ink from the plate and subsequently transfer it to the golf ball surface; hence the need for the surface tackiness of the ink. The stamp block is termed a “pad” and it is this term that has lent its name to this printing process. As the pad is lowered over the depressions in the surface of the plate, the tacky ink sticks to the pad. As the pad lifts, it takes with it not only the tacky, adhering film of ink, but also some excess fluid ink underneath. This film of ink is transferred from the pad to the target area on the dimpled golf ball surface. The time that elapses during this transfer process allows thinner to evaporate from the exposed ink on the silicone pad, creating another tacky surface of ink. As the pad is applied to the golf ball surface, the tacky film of ink adheres to the ball surface and separates from the pad as it is lifted from the surface. There is a fine balance between the amount of thinner in the inks and the transfer time, and it is this relationship that the ordinary-skilled artisan must employ to produce quality images with pad-printing.

The pad-printing process of adding logos to golf balls requires less time and is less expensive than the decal method, but pad-printing is still beset with obstacles. For example, most pad-printing machinery for use in the printing of golf balls is designed to employ a set number of colors, i.e., 2, 4, 6, or 8. In traditional pad-printing methods, the number of colors is usually equal to the number of wells which are used to apply the ink to the plate. Thus, where there are two shades of the same color, two inks and two ink wells are needed to apply the different shades to a golf ball.

As a result of these problems, there exists a need in the golf ball art for a process of easily and rapidly adding multiple colors or shading to logos used on golf balls.

U.S. Pat. No. 5,634,399 discloses a method and apparatus for adding patterns to golf balls. The method includes the steps of providing a pad-printing clichéwith a coating of titanium carbon nitride, forming a pattern on the coating, depositing ink on the pattern, removing excess ink, transferring the pattern to an ink transfer pad, and contacting a golf ball surface to transfer the pattern from the pad to the ball.

U.S. Pat. No. 5,734,800 discloses a printing system for high fidelity printing of an image that includes the steps of providing a print grid having a combination of the color black and five discrete basic ink colors, at least three of which have at least a portion of fluorescent molecules. The printing system also includes a spectrophotometer for measuring the color combination in the print grid. Readings from the spectrophotometer are used to create a table in CIE color space. The image to be printed is scanned and converted, based on the grid, to CIE color space.

U.S. Pat. No. 5,770,325 discloses a golf ball having an indicia formed from UV-curable ink. An ink composition and a method for applying an indicia to a golf ball are also disclosed. The UV-curable ink is reported to have excellent pad transfer properties and durability.

U.S. Pat. No. 5,778,793 discloses a method of adding a multicolor logo or a gradient-shaded logos to the dimpled surface of a golf ball. A method of adding a gradient-shaded or multicolored logo to a golf ball is also disclosed, in which a pattern or logo including more than one region is formed on a pad-printing cliché. Each region includes many depressions of substantially uniform depth and size, wherein the depressions are randomized such that there are at least two regions in which the distance between the depressions making up the region varies, creating a gradient shading effect. The number of colors is typically limited to four and each color may only be printed individually, and only opaque inks can be employed to attain the logo colors. If more than 4 colors are desired, correct alignment of the printing machinery to add the extra colors, called registration, is reported to be difficult. Furthermore, the use of a screen is required if additional colors are to be used, along with many additional or changed manufacturing steps, all which add to the total cost of printing a logo on golf balls.

U.S. Pat. No. 5,885,173 discloses a golf ball having an indicia formed from a UV curable ink containing aluminum trihydroxide (“ATH”) filler and a method for applying said indicia. The ATH is reported to improve pad-printing transfer of the ink. A UV-curable ink composition is disclosed as well.

Current pad-printing and ink technology employs a 4-color system including cyan, magenta, yellow, and black (“CMYK”), in which up to 50 percent of the Pantone Matching System® (“PMS”) colors are attainable by the various combinations cyan, magenta, yellow, and black. There does exist, though, a 6-color process, Hexachrome®, developed by Pantone®. Simply adding the ink colors orange and green to the four ink colors in the CMYK color space allow over 90 percent matching of PMS colors. Because these transparent inks “work in tandem,” a new 6-color set of inks, different from the CMYK inks has been developed. Therefore, it is clear that a novel method is needed for employing these new inks, using the pad-printing process, to apply logos and/or indicia onto three-dimensional surfaces, in particular, golf balls.

### SUMMARY OF THE INVENTION

The current invention is directed to a method of printing indicia on a golf ball having a dimpled surface including the steps of: providing a color image having a plurality of colors; saving the color image into computer memory as a digital image; creating at least six digital copies of the digital image; assigning at least one digital copy to each of at least six color channels; filtering the plurality of colors into the at least six color channels by removing all but an assigned color of that color channel from each corresponding digital copy, resulting in at least six color separations; creating a film positive for each of the at least six color separations; placing the film positive on a pad-printing cliché; etching the film positive into the pad-printing cliché creating a transfer image; distributing a layer of ink over the pad-printing cliché; and printing the transfer image from the surface of the pad-printing cliché to the dimpled surface of the golf ball.

In one embodiment, the method further includes scanning or creating the color image in RGB mode. The digital image is preferably imported into an image manipulation software program. In another embodiment, the method further includes sizing the digital copy to a predetermined size. In still another embodiment, the digital image has a tone that is adjusted to substantially match the color image. The digital image is preferably saved in a graphical format, preferably including tagged image file format and encapsulated postscript format. The color channels are preferably selected from the group consisting of cyan, magenta, yellow, black, orange, and green.

In one embodiment, the plurality of colors are filtered into the at least six discrete color channels using a color separation software program. In another embodiment, the at least six color separations are screened prior to creating the film positive. In still another embodiment, the screening further includes the steps of merging the color separations creating a flattened image, saving the flattened image as a grayscale image, converting the grayscale image to a bitmap image, diffusion dithering the bitmap image, and saving the bitmap image.

In still another embodiment, the layer of ink is distributed substantially homogeneously over the pad-printing cliché. Preferably, the ink includes a transparent ink. In another embodiment, printing the transfer image from the surface of the pad-printing cliché to the dimpled surface further includes a pad.

The present invention is also directed to a golf ball having a color indicia including a cover having an outer surface with a plurality of dimples, wherein the indicia is to be pad-printed on the outer surface and formed from at least six digital image copies of a color image including a plurality of colors, each digital image copy assigned to at least one of at least six color channels by filtering all but the corresponding color channel from each corresponding digital copy.

In one embodiment, each of the color channels has a color selected from the group consisting of cyan, magenta, yellow, black, orange, and green. In another embodiment, the at least six digital copies comprise scanning the color image in RGB mode. In an alternative embodiment, the digital image is saved in a graphical format. Preferably, the graphical format includes tagged image file format and encapsulated postscript format.

In one embodiment, the digital image is sized to a predetermined size. In another embodiment, the digital image copy has a tone that is adjusted to substantially match the color image. Preferably, the at least six digital copies are imported into an image manipulation software program. In a preferred embodiment, the at least six digital copies are screened prior to creating a film positive for the pad-printing. In yet another embodiment, the each of the digital image copies is flattened and saved as a grayscale images, the grayscale images being converted to bitmap images and dithered. Preferably, the indicia is formed from transparent inks.

### BRIEF DESCRIPTION OF THE DRAWINGS

Further features and advantages of the invention can be ascertained from the following detailed description that is provided in connection with the drawing described below.

FIG. 1 is a flow chart of one embodiment of the present invention.

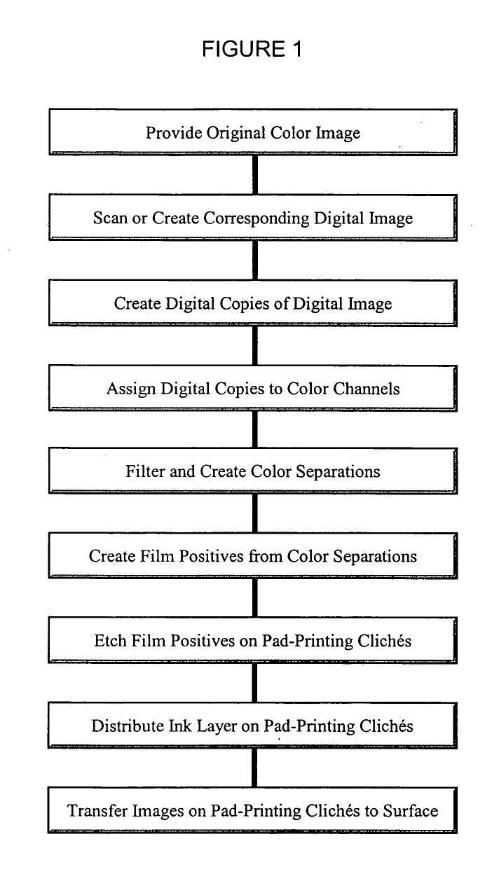

### DEFINITIONS

As used herein, the terms “pattern,” “image,” or “logo” are interchangeable for purposes of this invention and are considered to mean any symbol, letter, group of letters, design, image, etc. that can be added to the dimpled surface of a golf ball.

As used herein, the term “shading” is meant to encompass those circumstances where the intensity of a particular color is gradually reduced by reducing the number of pixels of that color, e.g., by increasing the distance between pixels.

As used herein, the term “gradient” refers to the rate of change in distance between pixels.

The term “about,” as used herein in connection with one or more numbers or numerical ranges, should be understood to refer to all such numbers, including all numbers in a range.

### DETAILED DESCRIPTION OF THE INVENTION

The present invention is directed to methods for printing high-fidelity color logos or patterns on three dimensional surfaces, more particularly, golf balls, and further incorporating a plurality of different colors and/or the formation of an image including a plurality of discrete elements which together form different regions of the image.

Any logo can be prepared using the method of the invention. It is preferred, however, that the logo be created by adding a logo to a computer memory so that the logo can be manipulated on the computer using one of many commercially available computer programs, such as Adobe Photoshop®. In particular, a piece of art work provided by a custom ball client can be transferred as a digital image into computer memory using any of the numerous means of transferring a document onto a computer memory, such as digitally scanning a printed image. Alternatively, the logo or pattern may be created in computer memory by using a commercially available design program, such as Adobe Illustrator® or Macromedia Freehand®, to create the logo directly on the system or modify downloaded image from a secondary source, such as the worldwide web, a CD-ROM, or a digital camera. Once the logo is in computer memory, the logo can be modified to make lines continuous or discontinuous and regions more, or less, distinct. Logos may also be evaluated for their accuracy compared to the original image. For example, if the color of the digital copy is subtly different from the original, tonal changes can be made to better match the digital copy to the original artwork. The various regions making up the logo are typically associated with different colors and/or shading effects that can be separated into the corresponding color channels. Although the invention is directed to a preferred process of pad-printing high-fidelity color indicia on the surface of a golf ball, other means for transferring the desired image to the ball surface are envisioned and may be substituted, such as an inkjet printing system.

In one embodiment, the logo or pattern to be printed on the golf ball is scanned into a computer as a graphic image in one of many color image formats, such as “RGB” (a 3-color system including red (“R”), green (“G”), and blue (“B”)) or “CMYK” (a 4-color system including cyan (“C”), magenta (“M”), yellow (“Y”), and black(“B”)). The RGB color space is limited to colors that can be defined as 0 to 100 percent red, 0 to 100 percent green, and 0 to 100 percent blue, whereas the CMYK color space is limited to colors which can be defined as 0 to 100 percent cyan, 0 to 100 percent magenta, 0 to 100 percent yellow, and 0 to 100 percent black. For true high-fidelity (“HiFi”) printing, color systems having more than four colors are required.

While 4-color systems have been the standard in the pad-printing industry for many years, HiFi color systems, such as a 6-color or 8-color system, are relatively new to the pad-printing industry. HiFi color is a process that achieves a superior visual appearance of color and imagery that is not possible with conventional 4-color process printing. HiFi color offers an expandable color gamut, as compared to that which is obtained through traditional printing methods. A 6-color system exists, known as Hexachrome®, that adds the colors orange (“O”) and green (“G”) to the conventional CMYK color space (“CMYKOG”), allowing for an even greater color range to be obtained. The Hexachrome® color system is available from Pantone, Inc. of Carlstadt, N.J., and is able to reproduce more brilliant continuous-tone images and is capable of simulating over 90 percent of solid Pantone Matching System (“PMS”) colors, almost twice that available using conventional 4-color systems. Color systems of eight or more colors also exist and would be well-suited for pad-printing golf balls according to the presently claimed process.

After scanning the original artwork or transferring a digital copy of the original artwork into a computer, the logo or image is then typically imported into image manipulation software, such as Adobe Photoshop®, that enables the image to be separated into the distinct colors (“color channels”) of the selected color system (e.g., CMYK), allowing designers to see, prior to printing, the design and color channel output. Preferably, at least a 4-color system, such as the CMYK color space, is used with the current invention, especially for images that require complex overlapping of colors to form colors different from the four primary colors of the CMYK process. More preferably, a 6-color system, such as the CMYKOG color space, is used.

In a preferred embodiment of the current invention, when an image, logo, or indicia is to be pad printed onto a dimpled golf ball surface, the color image is scanned into the memory of a computer. The image is preferably scanned or created in “RGB” mode (rather than “CMYK”) at a resolution sufficient to produce a quality scanned representative image. Preferably, the resolution of the scan is at least about 600 dots per inch (“dpi”). As stated above, RGB refers to the colors red, green, and blue. The RGB color space is preferred over the CMYK color space because the three colors represent a larger gamut of color than do cyan, magenta, yellow, and black. Those of ordinary skill in the art are well aware that the RGB color space provides richer color and is therefore better suited to providing quality images or logos from original artwork. Because commercially available scanners read the light, either through reflection or transparency, from an image in the RGB format, this color system is the most efficient way to convert color and/or light into the digital data often used in graphic systems. After scanning the original artwork, tonal adjustments (“cleaning up”) are generally made to the digital image so as to best replicate the original artwork and the desires of the client. After the image is cleaned up, it is preferably saved as an RGB image in a graphical format, preferably tagged image file format (“TIFF”) or encapsulated postscript format (“EPS”). It should be understood that the image in memory could be used directly for printing without any intermediate need to store the image on a magnetic or other media, such as a hard drive. The TIFF or EPS files that result from the RGB scan are smaller in size (i.e., take up less memory), allowing faster manipulation and processing, as well as requiring less data storage capabilities. The combination of these factors result in efficiency and cost reduction. Furthermore, if desired, one of ordinary skill in the art can easily convert an RGB image to a CMYK image.

After saving the digital image(s) in the desired format, if desired, the image can be further manipulated using graphical software, such as Adobe Illustrator®. Adobe Illustrator® is a vector-based drawing program that allows the graphic artist to draw lines, as opposed to the little “blocks” often generated by bitmap software programs. One of the features of Adobe Illustrator® allows the size of the digital image to be altered so that it more closely matches the size desired by the customer (and so that it might fit on a golf ball). At this point in the process, the digital image can then be copied and spaced to required template and production dimensions. Additionally, a separate copy of the full-color image is made corresponding to each specific color channel of the color space to be employed. For example, if the Hexachrome® CMYKOG 6-color space is used, six individual images of the logo (one for each discrete color in the 6-color space), are provided (in RGB mode). These “separated” images can then be saved in a standard graphic format, preferably TIFF or EPS.

The next step involves opening the digital image in Adobe Photoshop® (image manipulation software) in RGB mode. Within Adobe Photoshop®, a single RGB image is selected and is assigned to represent a single color channel (i.e., one image is assigned to the cyan color channel). Continuing the example above, one of the remaining five images is selected to correspond to the magenta color channel. This step is repeated until every color channel has been assigned to a single color. For each assigned image, the remaining five color channels are filtered (removed) from the image, for example by using HexWrench® software by Studion Soft Industries, Ltd., a plug-in for Adobe Photoshop®. For example, using the cyan example above, the image assigned to the cyan channel is filtered, removing any color component other than cyan. The resulting image, which now contains only the cyan component of the image, can then be saved as the “cyan color separation”. These steps are then repeated for the remaining five colors resulting in six distinct files each representing a single color component. Therefore, as described, this software plug-in enables the design to be separated, pre-press, into six individual colors, allowing designers to see and manipulate the design and six-channel output prior to printing.

Optionally, the logo can be created or scanned directly into Adobe Photoshop®, after choosing the desired color space, thus eliminating the added steps in Adobe Illustrator®. The image can be sized for the correct dimensions, as well as for resolution. The color channels are easily separated and can be printed directly from the application to the plate processor, with registration marks, if so desired.

Although any number of color channels may be used according to the current invention, the preferred color space is the Hexachrome® 6-color printing process developed by Pantone, Inc. The Hexachrome® color system provides improved color range and accuracy over 3- and 4-color processes. More importantly, though, it allows accurate reproduction of over 90 percent of the PMS colors, almost twice the number that can be obtained using conventional CMYK 4-color process printing. Using the Hexachrome® 6-color process eliminates the need for adding additional colors after processing, and thus eliminates the problem of poor registration, which is noticeable even to the untrained eye. The 6-color process also allows for on-line control of the printing process for making color or even total logo changes. Hexachrome® makes use of a special ink set developed by Pantone, Inc. that has enhanced versions of yellow (a new chemical formulation enhances lightfastness), magenta (a brighter, purer blend using rhodamine, instead of rubrine pigment, with added fluorescence to increase optical brightness), and cyan, as well as black, vivid orange, and green. An added benefit is that 4-color CMYK-color space jobs are still enabled. Additionally, ink consumption, even with two additional colors, is the about the same as with conventional 4-color processes.

The present invention can be used with any one of a number of image separation methods, and the Hexachrome® 6-color system supports both conventional halftone and stochastic screening, as well as gray-scale dithering. Stochastic screening involves imaging dots on film using special randomizing software, which uses mathematical expressions to statistically evaluate and randomly distribute pixels under a fixed set of parameters. The dots are identical in size and shape but the spacing between dots varies. Stochastic screening eliminates the problem of moiré patterns, screen rulings, and angles, and thus can lead to a significant improvement in image quality. Stochastic screening is also called frequency modulated (“FM”) screening, in which the ink density is controlled by varying the number of dots (dark areas receive more dots while light areas have fewer dots). Conventional “halftone” screening or amplitude-modulated (“AM”) screening, means simply increasing or decreasing the size (amplitude) of each dot while keeping the line spacing (screen ruling) equal.

While preferred methods of film generation is either AM or FM screening, the most preferred method employs the Spectrum Shading Process®developed by Acushnet Company that is described in U.S. Pat. No. 5,778,793 which is incorporated by reference herein.

After separating the RGB into individual images and further separating each image into the 6 colors channels (representing one of the CMYKOG colors) in the Hexachrome® color space, each color channel or layer is flattened (relative to a normalized intensity zero point) and saved as a grayscale image. The grayscale image is converted to a bitmap image using diffusion dithering. Preferably, the diffusion dithering is set at about 600 dpi. Finally, the bitmap image is saved as a final production copy.

After conversion and image manipulation, such as with Adobe Photoshop® and HexWrench®, the logo can then be added to a medium that can serve as a positive for addition of the logo to a plate (pad-printing cliché). According to the present invention, creating the plate is accomplished by situating the film positive, containing the image of the logo, over a blank plate. Any plate capable of accepting an image and performing as a pad-printing cliché can be used according to the present invention. Preferably, the plate is photopolymer plate, and more preferably, a variable relief photopolymer plate. The photopolymer plate typically includes four sections: a base layer, an adhesive layer, a relief layer, and a protective film. Treated carefully, photopolymer plates can produce several thousand impressions. A metal backing plate (the base layer) is coated with a photosensitive polymer (the relief layer), which can polymerize under the action of radiation such as ultraviolet (“UV”) light, thereby becoming hard.

The base layer may be constructed of a variety of materials, such as steel, aluminum, plastic, or a combination thereof, but is preferably steel. The thickness of the photopolymer plate is typically from about 0.01 inches to 0.04 inches, preferably about 0.02 inches. A layer of adhesive is used to join the base layer to the relief layer. The relief layer is the actual photopolymer material in which the etched image is created. The relief layer may be made of any photosensitive polymer material suitable for curing with radiation. Suitable polymers include polyester, nylon, acrylate class polymers, or any other polymer readily selected by one of ordinary skill in the art. The thickness of the relief layer is typically from about 0.001 inches to 0.03 inches, preferably about 0.008 inches. Plates having a polymer layer thereon are commercially available. One example of a suitable photopolymer plate is the “WSA 52” Nylograv plate from BASF Corp. of Stuttgart, Germany.

When the positive of the logo is situated above the plate, UV light is introduced to the surface of the plate that is not covered by the logo. In a preferred mode of the present invention, UV light is supplied by a plate exposure unit such as those available from Jet U.S.A. Corp. of Collingdale, Pa., as Jet Model JEA3-SS, or a Transtech America, Inc. exposure unit such as model #M10355 or 142202. The plate and logo may be exposed to UV light of a sufficient intensity and time to harden the polymer coated surface of the plate that is subjected to the UV light. A preferred exposure period is from about 1 s to 270 s, or, more preferably, for a period of from about 45 s to 180 s. The most preferred exposure period is 75 s.

Often, after the initial exposure period, the logo and plate are completely covered with a screen film and further irradiated with UV light. Screening the image creates a series of bumps in the shape of truncated cones within the etched depressions of the image on the plate. The purpose of screening is two-fold. First, if the etched image contains large regions between features, the doctor blade, used for spreading and removing excess ink, may drop into the depression as it translates across the plate to remove excess ink. This can result in an uneven distribution of ink on the plate and, subsequently, an irregular image on the golf ball surface. The second purpose of screening is that the density and height of the cones allow for more precise control of the ink transfer properties. The quality and sharpness of the printed image are still maintained, as the screen spots show very slightly at the edges.

The screen film can have frames of about 50 to 1,000 lines per inch or, more preferably, from about 100 to 400 lines per inch. It is most preferred to employ a screen having approximately 300 lines per inch. Screens also have a tint (the density of bumps) that can be varied while keeping the line frequency the same. The tint also helps control the ink transfer and typically ranges from about 50 to 100 percent tint. Preferably, the tint is about 80 to 90 percent tint. Most preferably, the tint is about 86 percent tint.

When the screen is situated over the image, a second exposure of UV light further cures any photopolymer not blocked by the screen lines. This second exposure is typically about 25 to 50 seconds, preferably about 30 to 40 seconds. Most preferably, the second exposure is about 35 seconds.

After exposure to UV light, the plate can be washed to remove any polymer on the surface that was not hardened through exposure to UV light (i.e., the polymer material that was blocked from UV irradiation by the image positive and/or screen film). The removal of such uncured polymer material can be accomplished by any method, such as with water or an alcohol-based solvent, preferably water. Apparatus for removing uncured polymer are commercially available from Jet U.S.A. Corp. of Collingdale, Pa., such as Jet Model JW-A3-PD. The brushes employed in these washing units typically contain nylon bristles and can wash out uncured polymer material to a useful depth of about 0.001 inches. Excess water can be removed from the plate using compressed air, a sponge roll, or a combination thereof. Preferably, the excess water is removed using compressed air.

Upon drying, the plate or pad-printing cliché is heated to a temperature sufficient to remove substantially all water from the surface. The plate can be heated to about 50° C. or higher for a period of from about 1 minute to about 5 hours in an oven to harden the polymer coating on the cliché. Preferably, the plate is heated for a period of about 5 minutes to about 30 minutes. Most preferably, the plate is heated for about 15 minutes.

When heat treatment is completed, the plate may then be subjected to an exposure of UV light for a period of from about 1 minute to about 5 hours or more. More preferably, the plate is exposed to UV light for a period of from about 1 minute to about 1 hour. Most preferably, the plate is exposed to UV light for about 5 minutes.

While the above-described process describes one method of preparing the pad-printing clichés used to transfer the ink to the spherical dimpled surface of a golf ball, there are numerous other methods well known to the person of ordinary skill in the art that can be used to perform the same function. For example, two additional possibilities that are envisioned are the use of direct-to-plate (“DTP”) gravure plates and the use of laser etching to transfer the image to the plates. The DTP process, developed by BASF of Germany, involves three main steps: main exposure, washout, intermediate exposure/drying/post exposure. The main exposure transfers the halftone and line elements to the plate, wherein exposed areas polymerize and become unsoluble. This step also allows fine control of the etch depth by precise variation of exposure time. The washout step dissolves and removes all or substantially all of the unpolymerized material. The final step gives the plate the necessary hardness for a long run life and causes evaporation of the washout liquid absorbed by the photopolymer layer.

An additional process for washing the uncured polymer from the plates involves a washing unit containing a soft brush made of a plush material. The bristles are arranged into plugs that allow the material to be very soft, yet robust enough to remove uncured polymer from the plates in a much-improved fashion. The plush material allows for better control of the depth of etch, as well as providing a more homogeneously-flat bottom surface. Additionally, the plush material is less likely to leave swirl or bristle marks, sometimes associated with conventional brush bristles, in the polymer surface at the bottom of the etch. The depth variation is especially problematic when the image to be printed has large “open” areas to be filled with ink, i.e., when printing spot colors. Therefore, gaining much finer control over the profile of the bottom of the etched area significantly aids in better controlling the amount of ink that is available at any given area within the etch.

The plush brush is attached to a metal platen which is directionally- and time-controlled by a motor connected to the platen. Suitable ways of adjusting platen pressure will be readily known to those of ordinary skill in the art. The finer control of the pressure on the platen, combined with the more even wash out, allows for finer control of the etch depth. The depth of etch should preferably be less than about 0.001 inches, and more preferably between about 0.0005 inches and 0.001 inches. Most preferably, the depth of etch should be between about 0.0006 inches and 0.0007 inches.

Pad-printing clichés, made according to the aforementioned procedure, can be used in a pad-printing machine to print logos onto the dimpled surface of golf ball using machines such as the Teca-Print® TP-100. The TP-100 is also capable of printing 2-color logos and is capable of producing 1-color work at a rate of 30 pieces per minute and 2-color work at 21 pieces per minute. Three and four color logos can be printed on balls using the Teca-Print® 4-color machines. These are custom designed machines in which the operator must place the golf balls into ball holding fixtures located on an indexing oval “carousel” conveyor. There are multiple ball holding fixtures located on the oval track. The basic design of the Teca-Print® 4-color machines is two Teca-Print® TP-100 2-color machines integrated with a Teca-Print® pneumatic transfer carousel, 14-station, 4.5-inch indexing system. These systems can produce 19 pieces per minute.

Any type of ink may be used in the printing process of the present invention. There are numerous types of inks available within the printing industry, such as solvent evaporating inks, oxidation curing inks, reactive (catalyst curing or dual-component) inks, baking inks, UV curable inks, sublimation inks, and ceramic and glass inks.

Solvent-based inks are predominant in the pad-printing industry, as they dry very rapidly through solvent evaporation alone. They are very versatile inks, as they are available in both gloss and matte finishes and perform very well with many thermoplastic substrates. Oxidative curing inks have limited uses in pad-printing applications due to their slow drying speed. They do, however, produce very tough, flexible, weather-resistant ink films and are very useful for printing onto metal and glass surfaces.

It is possible to use 1-component inks because their long shelf life can make them easier to work with and more economical. Some 1-component inks are highly resistant to abrasion and solvents. Curing can take place physically or by oxidation.

Dual-component inks are also used extensively in pad-printing and contain resins capable of polymerization. These inks cure very rapidly, especially when heated and are generally good for printing on substrates such as metals, some plastics, and glass, and have very good chemical and abrasion resistance. The inks, though, do have a restricted shelf life once the polymerization catalyst has been added. With 2-component inks, curing typically takes place over about a 5-day period at a temperature of about 20° C., or over about a 10 minute period at a temperature of about 100° C.

Ceramic and gas (thermo) diffusion inks are also used in the pad-printing industry. These inks are solid at room temperature and must be heated in the ink reservoir to a temperature greater than about 80° C. Unlike solvent evaporating inks, pad wetting occurs due to the cooling effect the pad has on the heated ink rather than because of the evaporation of solvent. Ink transfer occurs because the outer surface of the ink becomes tacky when exposed to air. The ink transfer is aided by the cooler surface of the substrate to be printed on.

Ultraviolet ink can also be used in the present invention. UV inks are typically cured by means of UV light having wavelengths of from about 180 nm to 380 nm. The advantages of using a UV ink are that they are fast and cure thoroughly, they are easy to use and are not affected by small changes in ambient conditions, they retain constant viscosity (i.e., they do not dry up quickly), and they use smaller amounts of combustible organic solvent, such that little or no solvent fumes escape into the working environment and are, therefore, environmentally safer. Small amounts of solvent may be added to the UV inks for certain application to enable the ink to transfer in a conventional manner.

The inks may optionally contain additives such as binders, reactive prepolymers, thinners, low-viscosity mono and poly-functional monomers, photoinitiators to stimulate polymerization, stabilizing additives, flow control agents, wetting agents, pigments, extenders, or combinations thereof.

The film of ink is transferred to the predetermined three-dimensional surface. In a preferred embodiment, the surface is the dimpled surface of a golf ball. In an alternative embodiment, other three-dimensional surfaces, such as golf clubs and golf shoes, are envisioned for use with the present invention. The thickness of the ink film transferred to a golf ball can be any thickness that is sufficient to provide a clear image of the logo and can vary with the ink type and color. The thickness of the ink film is also influenced by the viscosity of the ink, the pad material, the depth of etching in the plate, and environmental factors, such as temperature, humidity, and so on. This thickness can be between about 4 μm and 50 μm, preferably from about 4 μm to 20 μm.

The color logo or image may be printed over or under a clearcoat. Preferably, the color indicia is printed under the clearcoat.

After the printing process is complete, the three-dimensional objects can be removed to a dry room to finally cure the ink used for the logo. The dry room is maintained at an elevated temperature to aid in drying the logo ink. The dry room is typically kept at about 40° C. and the balls are usually kept in the dry room for approximately 4 hours at that temperature.

The invention described and claimed herein is not to be limited in scope by the specific embodiments herein disclosed, since these embodiments are intended solely as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

What is claimed is:

1. A method of printing indicia on a golf ball having a dimpled surface including the steps of:
providing a color image having a plurality of colors;
saving the color image into a computer memory as a digital image;
creating at least six digital copies of the digital image;
assigning at least one digital copy to each of at least six color channels;
filtering the plurality of colors into the at least six color channels by removing all but an assigned color of that color channel from each corresponding digital copy, resulting in at least six color separations;
creating a film positive for each of the at least six color separations;
placing the film positive on a pad-printing cliché;
etching the film positive into the pad-printing cliché creating a transfer image;
distributing a layer of ink over the pad-printing cliché; and
printing the transfer image from the surface of the pad-printing cliché to the dimpled surface of the golf ball.

2. The method of claim 1, wherein the method further comprises scanning or creating the color image in RGB mode.

3. The method of claim 1, wherein the digital image is imported into an image manipulation software program.

4. The method of claim 1, wherein the method further includes sizing the digital image to a predetermined size.

5. The method of claim 1, wherein the digital image has a tone that is adjusted to substantially match the color image.

6. The method of claim 1, wherein the method further comprises saving the digital image in a graphical format.

7. The method of claim 6, wherein the graphical format comprises tagged image file or encapsulated postscript formats.

8. The method of claim 1, wherein each of the color channels has a color selected from the group consisting of cyan, magenta, yellow, black, orange, and green.

9. The method of claim 1, wherein the step of filtering the plurality of colors further comprises using a color separation software program.

10. The method of claim 1, wherein the at least six color separations are screened prior to creating the film positive.

11. The method of claim 10, wherein the screening further includes the steps of merging the color separations creating a flattened image, saving the flattened image as a grayscale image, converting the grayscale image to a bitmap image, diffusion dithering the bitmap image, and saving the bitmap image.

12. The method of claim 1, wherein the layer of ink is distributed substantially homogeneously over the pad-printing cliché.

13. The method of claim 12, wherein the ink comprises a transparent ink.

14. The method of claim 1, wherein printing the transfer image from the surface of the pad-printing cliché to the dimpled surface further comprises a pad.

15. A golf ball having a color indicia comprising:
a cover comprising an outer surface with a plurality of dimples, the indicia being pad printed on the outer surface and formed from at least six digital image copies of a color image comprising a plurality of colors, each of the at least six digital image copies assigned to at least one of at least six color channels by filtering all but the corresponding color channel from each corresponding digital copy.

16. The golf ball of claim 15, wherein the at least six digital copies comprise scanning or creating the color image in RGB mode.

17. The golf ball of claim 15, wherein the at least six digital copies are imported into an image manipulation software program.

18. The golf ball of claim 15, wherein the at least six digital image copies are sized to a predetermined size.

19. The golf ball of claim 15, wherein the at least six digital image copies have a tone that is adjusted to substantially match the color image.

20. The golf ball of claim 15, wherein the at least six digital image copies are saved in a graphical format.

21. The golf ball of claim 20, wherein the graphical format comprises tagged image file and encapsulated postscript formats.

22. The golf ball of claim 15, wherein each of the color channels has a color selected from the group consisting of cyan, magenta, yellow, black, orange, and green.

23. The golf ball of claim 15, wherein the at least six digital copies are screened prior to creating a film positive for the pad-printing.

24. The golf ball of claim 23, wherein the each of the at least six digital image copies is flattened and saved as a grayscale image, the grayscale image being converted to a bitmap image and dithered.

25. The golf ball of claim 15, wherein the indicia is formed from transparent inks.
